(19) United States
(12) Patent Application Publication
(10) Pub. No.: US 2013/0112296 A1
(43) Pub. Date: May 9, 2013

(54) MICROFLUIDIC APPARATUS AND MICROFLUIDIC SYSTEM HAVING THE SAME

(71) Applicant: SAMSUNG ELECTRONICS CO., LTD., Suwon-si (KR)

(72) Inventors: Young Goun LEE, Seoul (KR); Chung Ung KIM, Yongin-si (KR); Ki Ju LEE, Suwon-si (KR)

(73) Assignee: SAMSUNG ELECTRONICS CO., LTD., Suwon-si (KR)

(21) Appl. No.: 13/673,247

(22) Filed: Nov. 9, 2012

(30) Foreign Application Priority Data
Nov. 9, 2011 (KR) 10-2011-0116274

(51) Int. Cl. B01L 3/00

(52) U.S. Cl. CPC B01L 3/5027
USPC 137/559

(57) ABSTRACT

A microfluidic system capable of determining at least one of the existence and the amount of a fluid by use of an optical sensor even if the fluid is transparent. The microfluidic system includes a platform including at least one chamber configured to accommodate a fluid, at least one channel connected to the at least one chamber, and at least one protrusion disposed on an inner surface of the at least one chamber and configured to show a difference in transmittance according to the existence of the fluid.

### CROSS-REFERENCE TO RELATED APPLICATION

This application claims priority from Korean Patent Application No. 10-2011-0116274, filed on Nov. 9, 2011 in the Korean Intellectual Property Office, the disclosure of which is incorporated herein by reference.

### BACKGROUND

1. Field

Apparatuses and articles of manufacture consistent with exemplary embodiments relate to a microfluidic apparatus and a microfluidic system having the same, and more particularly, to a microfluidic apparatus and a microfluidic system having the same provided with a microfluidic structure capable of determining the existence and the amount of a fluid.

2. Description of the Related Art

A driving pressure is needed to move a fluid within a microfluidic structure, and the pressure of a capillary tube or the pressure of a separate pump may be used as the driving pressure. A disc-type microfluidic apparatus configured to accommodate a microfluidic structure at its disc-shaped body, move a fluid using centrifugal force, and perform a series of tasks has recently been suggested. The disc-type microfluidic apparatus is referred to as a Lab compact disc (CD), a Lab-on-a-disc, or a Digital Bio Disc (DBD).

In general, a disc-type microfluidic apparatus includes a chamber capable of capturing and storing a fluid, a channel through which the fluid may flow, and a valve capable of controlling the flow of fluid. Any of various combinations of the chamber, the channel and the valve may be included in the disc-type microfluidic apparatus.

A microfluidic apparatus may be used as a sample testing apparatus to test a sample such as blood, saliva, and urine. Inside the microfluidic apparatus may be provided a reagent, which reacts to a particular material of a sample, disposed therein. A sample may be tested by injecting the sample into the microfluidic apparatus and detecting a result of a reaction between the sample and the reagent.

In a case when an optical sensor is used to detect a result of a reaction of the sample and reagent, the detecting of the reaction may be achieved by identifying the color of the fluid directly through use of the optical sensor. In the case of a transparent fluid, the detecting of the reaction may be achieved by injecting a new sample and detecting a change in the color of the fluid so that the existence and the amount of the fluid may be checked.

In such cases, a new sample needs to be injected, and thus a new manufacturing process must be developed, thereby increasing cost, and potentially influencing the fluid with the new sample.

### SUMMARY

Exemplary embodiments provide a microfluidic apparatus and a microfluidic system having the same capable of determining at least one of the existence and the amount of a fluid by using an optical sensor, even when the fluid is transparent.

In accordance with an aspect of an exemplary embodiment, there is provided a microfluidic apparatus including a platform including at least one chamber, at least one channel and at least one protrusion. The at least one chamber may be configured to accommodate a fluid. The at least one channel may be configured to connect to the at least one chamber. The protrusion may be disposed on an inner surface of the at least one chamber and provided to show a difference in transmittance according to an existence of the fluid.

A boundary part of the protrusion may be formed having a side slanted with respect to an inner wall of the chamber.

The at least one protrusion formed protrudes from a bottom surface of the chamber.

A surface of at least one protrusion has a uniform pattern formed therein.

The pattern may be formed by etching.

The at least one protrusion may include a plurality of protrusions forming a uniform pattern.

The at least one chamber may include an injection chamber into which the fluid is injected, and the injection chamber is provided at an inner side thereof with the protrusion.

The at least one chamber may include a metering chamber configured to accommodate and discharge a determined amount of a fluid, and the metering chamber is provided at an inner side thereof with the protrusion.

The at least one chamber may include a reaction chamber in which a reaction of the fluid takes place.

The at least one chamber may include a checking chamber configured to check whether the fluid is entirely injected into the reaction chamber, and the checking chamber is provided at an inner side thereof with the protrusion.

In accordance with another aspect, there is provided a microfluidic system including a microfluidic apparatus, a light source and an optical sensor. The microfluidic apparatus may include a platform including at least one chamber provided configured to accommodate a fluid and having a protrusion disposed on an inner surface thereof , and at least one channel connected to the at least one chamber. The light source may be configured to radiate optical energy to the chamber. The optical sensor may be configured to determine at least one of an existence or an amount of the fluid within the chamber using the optical energy passing through the chamber.

A boundary part of the protrusion may have a side that is slanted with respect to an inner wall of the chamber.

The protrusion may be provided in at least one chamber thereof.

The at least one protrusion may form a uniform pattern.

The at least one chamber may include at least one of among an injection chamber, a metering chamber, and a checking chamber, the injection chamber configured to have the fluid injected thereinto, the metering chamber configured to accommodate and discharge a determined amount of a fluid, and the checking chamber comprising a reaction chamber, in which a reaction of a fluid takes place, and configured to check whether the fluid is entirely injected to the reaction chamber.

At least one of among the injection chamber, the metering chamber and the checking chamber may be provided with the protrusion disposed on at an inner surface thereof.

The microfluidic apparatus may be positioned in between the optical sensor and the light source.

The platform may be configured to be rotated, and disposed on an inner surface of the at least one chamber may be the protrusion formed is formed in a direction extending in the direction of centrifugal force caused by rotation of the microfluidic apparatus.

The at least one protrusion may include a plurality of protrusions forming a uniform pattern.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a perspective view illustrating a microfluidic apparatus in accordance with an exemplary embodiment.

FIG. 2 is a plane view schematically illustrating a structure of a microfluidic apparatus in accordance with an exemplary embodiment.

FIG. 3 is an enlarged perspective view illustrating a chamber in accordance with an exemplary embodiment.

FIG. 4 is an enlarged cross sectional view illustrating a microfluidic system in accordance with an exemplary embodiment.

FIG. 5 is an enlarged cross sectional view illustrating a microfluidic system in accordance with another exemplary embodiment.

FIG. 6 is an enlarged cross sectional view illustrating a microfluidic system in accordance with still another exemplary embodiment.

FIG. 7 is an enlarged cross sectional view illustrating a microfluidic system in accordance with still another exemplary embodiment.

FIG. 8 is an enlarged view illustrating a microfluidic apparatus in accordance with still another exemplary embodiment.

### DETAILED DESCRIPTION

Reference will now be made in detail to the embodiments, examples of which are illustrated in the accompanying drawings, wherein like reference numerals refer to like elements throughout.

The structure of a microfluidic apparatus according to an exemplary aspect may be applied to various microfluidic apparatuses. However, a microfluidic apparatus having a metering chamber, a checking chamber, and an injection chamber will be explained hereinafter.

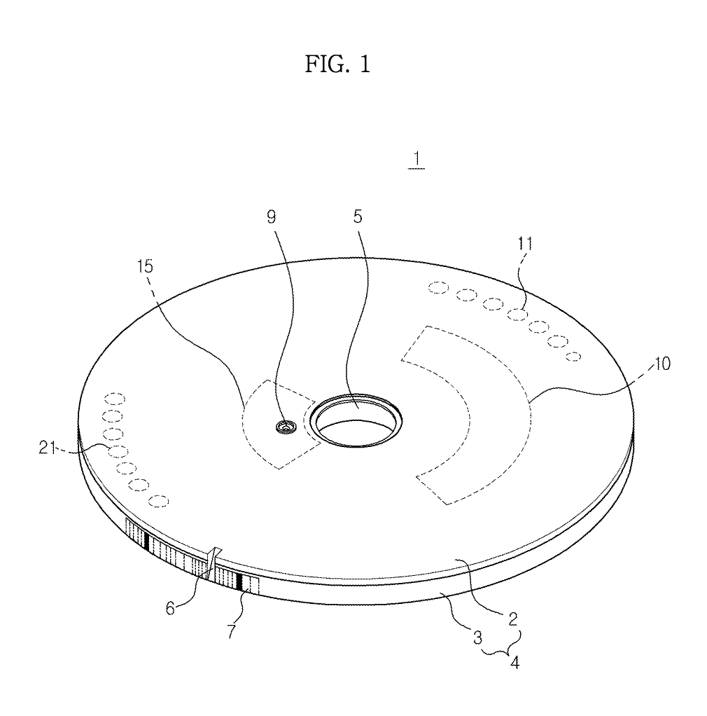

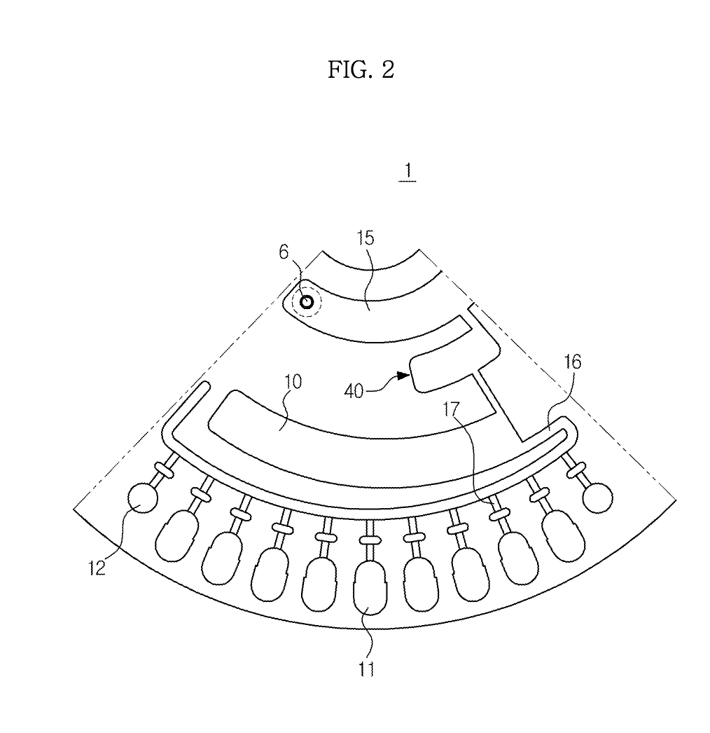

FIG. 1 is a perspective view illustrating a microfluidic apparatus in accordance with an exemplary embodiment. FIG. 2 is a plane view schematically illustrating a structure of a microfluidic apparatus in accordance with an exemplary embodiment.

As illustrated in FIGS. 1 to 2, a microfluidic apparatus 1 includes a disc-shaped platform 4 configured to rotate, at least one chamber disposed within the platform 4 for a fluid to be accommodated therein, at least one channel for a fluid to flow therethrough, and a bar code 7 provided at a side surface of the platform 4.

The platform 4 may be rotated having a center 5 thereof as an axis of rotation. Movement, centrifugal separation, and mixing of a sample may take place within the chamber and the channel disposed within the platform 4 through centrifugal force according to the rotation of the platform 4.

The platform 4 may be made of plastic material having a biologically inactive surface, such as acryl, PDMS, and PMMA. However, the platform 4 is not limited hereto, and may be made of other material as long as the material has chemical and biological stability, optical transparency and mechanical processability.

The platform 4 may be formed with multiple layers of plates. An engraved structure corresponding to a chamber or a channel may be formed at a surface at which the plates make contact with each other. Thereafter, the plates are attached to each other, thereby forming a space and a path within the platform 4.

As an example, the platform 4 may have a structure including a first substrate 2 and a second substrate 3 attached to the first substrate 2, or a structure including a partition plate (not shown) configured to define at least one chamber in which a fluid may be accommodated between the first substrate 2 and the second substrate 3 and at least one channel through which a fluid may flow. In addition, the platform 4 may also be provided with various shapes thereof. The first substrate 2 and the second substrate 3 may be formed from a thermoplastic resin.

The attachment of the first substrate 2 and the second substrate 3 may be performed by using an adhesive or a double-sided tape, an ultrasonic welding, a laser welding, or using other various methods.

Hereinafter, the microfluidic structure disposed within the platform 4 to test a sample will be explained.

A sample may be formed as a mixture of a fluid and a material, such as a particle having a greater density than the fluid. As an example, the sample may be a biological sample such as blood, saliva, and urine.

An injection chamber 15 may be disposed at a radial inner side of the platform 4. The injection chamber 15 may be divided to accommodate a predetermined amount of the sample, and may be provided with a sample injection hole 9 at an upper surface thereof for injecting the sample into the injection chamber 15.

In certain embodiments, the entire sample may be used for a test using a fluid. In addition, a sample separating chamber (not shown) may be provided at a radial outer side of the injection chamber 15 to centrifugally separate the sample using the rotation of the platform 4. In addition, the sample separating chamber (not shown) may be provided with a space to accommodate sediment having a relatively greater weight, and a separate space to accommodate a sample having a relatively less weight therein.

In addition, the sample may be introduced to a metering chamber 40 for metering an amount of sample needed for a test. As shown in FIG. 2, the metering chamber 40 is connected to the injection chamber 15, but this configuration is not limited hereto, and the metering chamber 40 may be connected to other microfluidic structures. For example, the metering chamber 40 may be connected to the sample separating chamber (not shown).

Attached to the metering chamber 40 may be provided a sample eliminating chamber (not shown) to eliminate the sample remaining after the metering is performed by the metering chamber 40.

A dilution chamber 10 may also be provided within the microfluidic apparatus 1 and connected to the metering chamber 40. The dilution chamber 10 may be configured to be supplied with the sample that is metered in a predetermined amount. In certain embodiments, a plurality of dilution chambers 10 may be provided so that a different amount of dilution buffer may be stored in each dilution chamber 10, and the volume of each dilution chamber 10 may be different from each other according to the volume of the dilution buffer needed.

An exit hole of the dilution chamber 10 may be connected to a distribution channel 16. The distribution channel 16 may include a first section extending toward an outer side of the platform 4 from the exit hole of the dilution chamber 10, and a second section extending from an end of the outer side of the first section along a circumferential direction of the microfluidic apparatus. An end portion of the second section may be connected to an vent hole (not shown). The vent hole (not shown) may be disposed at a position such that the sample does not leak therethrough while moving to the distribution channel 16 from the dilution chamber 10 by centrifugal force.

A plurality of reaction chambers 11 may be disposed at an outer side of the dilution chamber 10. In embodiments where a plurality of diluting chambers 10 are provided, a group of reaction chambers 11 may be disposed at an outer side of each diluting chamber.

Each reaction chamber group may include at least one reaction chamber 11. The reaction chamber 11 is connected to the corresponding dilution chamber 10 through distribution channel 16 that distributes the dilution buffer. In certain embodiments, each of the reaction chamber groups may be provided as a single reaction chamber 11.

The reaction chamber 11 may be formed as a sealed type chamber. As used herein, a sealed type chamber refers to a chamber provided with no vent to exhaust air from the respective reaction chamber 11. Various types or various concentration levels of reagent may be injected in advance into the at least one reaction chamber 11, so as to cause optically detectable reactions when the reagent reacts with the sample and the sample dilution buffer that is distributed through the distribution channel 16. Exemplary optically detectable reactions include, but are not limited to, florescence or a change in light absorbance.

However, the present disclosure is not limited, and the at least one reaction chamber 11 may be a chamber provided with a vent and an injection hole thereto.

In various embodiments that include a plurality of reaction chamber groups, at least one reaction chamber from each reaction chamber group may store therein a reagent that is appropriate for the reaction with a sample dilution buffer having the same dilution ratio.

As an example, a first reaction chamber group may store reagents such as TRIG (triglycorides), Chol (total cholesterol), GLU (glucose), and BUN (blood urea nitrogen), each of which reacts under a condition in which the dilution ratio of a dilution buffer to a sample is about 100, stored therein. A second reaction chamber group may then store reagents such as DBIL (direct bilirubin), TBIL (total bilirubin), and GGT (gamma glutamyl transferace), each of which reacts under a condition in which the dilution ratio of a dilution buffer to a sample is about 20, stored therein.

That is, since at least one reaction chamber belonging to a second reaction chamber group is supplied with a sample dilution buffer having a dilution rate different from a dilution rate of a sample dilution buffer supplied to the first reaction chamber group, the reaction chambers of each reaction chamber group are able to store reagents that are appropriate for a sample having a certain dilution rate.

In certain embodiments, the reaction chambers 11 may be provided with the same volume formed therein. However, such a configure is not limited hereto, and in a case where a sample dilution buffer or a sample is needed at different volumes, depending on the category of test being performed, the reaction chambers 11 may be configured to have different volumes from each other.

The reaction chambers 11 are connected to the second section of the distribution channel 16 through entry channels 17, respectively.

In addition, the microfluidic apparatus 1 may include a checking chamber 12 to check whether the sample mixture is entirely injected into the reaction chambers 11. The reagent is not accommodated in the checking chamber 12. The checking chamber 12 is provided at an end portion of the distribution channel 16 furthest from the dilution chamber 10. As such, the sample mixture is first filled in the reaction chamber that is nearest to the dilution chamber 10, and is lastly filled in the checking chamber 12. Thus, the determination as to whether the sample mixture is filled in all of the reaction chambers 11 may be made by checking whether the sample mixture is filled in the checking chamber 12.

A valve (not shown) may be provided at a channel connecting each chamber. The valve (not shown) may be provided in any of various types and configurations thereof, such as a capillary valve that is manually opened as applied pressure exceeds a certain level, or a valve that is actively operated by receiving power or energy from an outside source, such as an operating signal.

In addition, a lateral side 3 of the platform 4 is provided with a bar code 7 affixed thereto. The bar code 7 may store information such as a manufacture date and/or an expiration date of the microfluidic apparatus 1, as needed.

The bar code 7 may be a one dimensional bar code. In certain embodiments, the bar code 7 may be provided in any of various forms of bar codes, such as a matrix code and/or a two dimensional bar code.

The bar code 7 may be replaced with a hologram, a RFID tag, and/or a memory chip that are capable of storing information. In addition, in embodiments where a storage medium, such as a memory chip that is configured to read and write information, is used in place of the bar code 7, the storage medium may store not only identification information, but also information on a sample test result, patient, date and time of the test performed, blood collection information, and/or whether or not a test was performed.

In addition, the lateral side 3 of the platform 4 of the microfluidic apparatus 1 may be provided with a home position identifier 6, which may be in the form a reflective member, to establish a reference position of the microfluidic apparatus 1.

A quality check (QC), checking whether the microfluidic apparatus 1 performs normally, may be needed to assure the reliability of a test performed. With reference to the QC, checking for the existence of or the amount of a fluid within a chamber of the microfluidic apparatus 1 is needed to determine whether a test is performed normally.

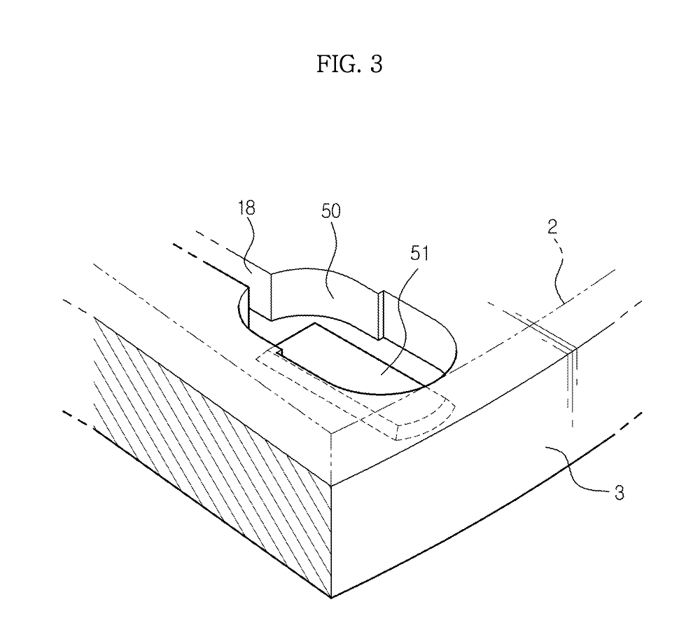

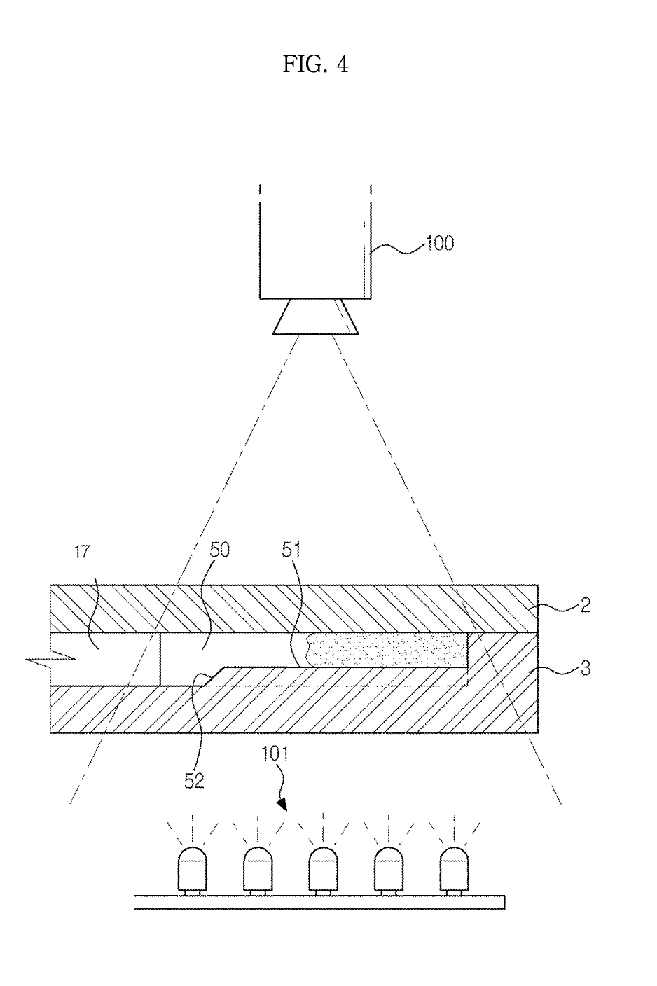

FIG. 3 is an enlarged perspective view illustrating a chamber in accordance with an exemplary embodiment. FIG. 4 is a cross sectional view illustrating a microfluidic system in accordance with an exemplary embodiment.

As illustrated in FIGS. 3 to 4, a chamber 50 of a microfluidic apparatus according to an exemplary embodiment includes a protrusion 51 disposed at an inner side thereof. The protrusion 51 may be provided at a chamber needed for the QC, but such a configuration is not limited thereto.

As an example, an inner surface of the injection chamber 15 may be provided with the protrusion 51, and in such cases, a determination may be made as to whether a sample is injected into the injection chamber 15 or whether a predetermined amount of a sample is injected to the injection chamber 15.

In addition, the protrusion 51 may be provided on an inner surface of the metering chamber 40. In this case, a determination may be made as to whether a sample needed to perform a test has been injected and metered.

In addition, the protrusion 51 may be formed at an inner surface of the checking chamber 12 which is provided at the reaction chamber group. In such a case, a sample mixture is lastly filled in the checking chamber 12 after the sample mixture has filled the reaction chambers 11, and thus a determination may be made as to whether the sample mixture is filled at the checking chamber 12.

As discussed above, the protrusion 51 may be provided in any of the metering chamber 40, the injection chamber 15, and the checking chamber 12, but not such configurations are not limited hereto, and the protrusion 51 may also be used in determining the existence of or the amount of a fluid within the chamber 50.

The chamber 50 of the microfluidic apparatus 1 may be positioned in between a light source 101 and an optical sensor 100. The existence of or the amount of a fluid may be determined by radiating optical energy from the light source 101 to the chamber 50 and then detecting the optical energy radiated by use of the optical sensor 100. A light emitting device such as a back light unit (BLU) and a light emitting diode (LED) may be used as the light source 101 of the microfluidic system. The optical sensor 100 may include a camera. The protrusion 51 disposed at an inner surface of the chamber 50 may be integrally manufactured as the microfluidic apparatus 1 is injection-molded.

In general, air and the chamber 50 having the protrusion 51 show a large difference in the rate of transmittance. However, when a fluid flows into the chamber 50 and fills the chamber 50 with fluid in place of air, the difference in the rate of transmittance is reduced. As a result, the difference in the rate of transmittance is generated within the chamber 50 depending on the existence of the fluid, so a determination on the existence of the fluid in the chamber 50 may be made. That is, in a case when a fluid is in the chamber 50, the edge of the protrusion 51 is seen as light-colored compared to the case when a fluid is not in the chamber 50.

A boundary part 52 disposed at an edge of the protrusion 51 may be formed as a slanted or inclined edge with respect to an inner wall of the chamber 50. As such, the difference in the rate of transmittance may be easily detected when the optical sensor 100 photographs from an upper side and a lower side of the microfluidic apparatus 1.

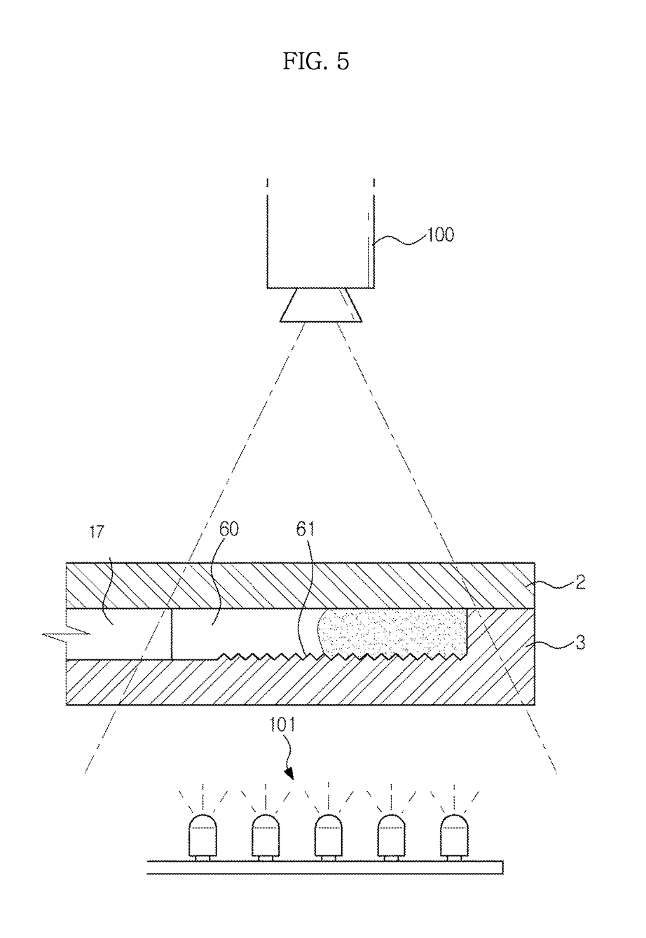

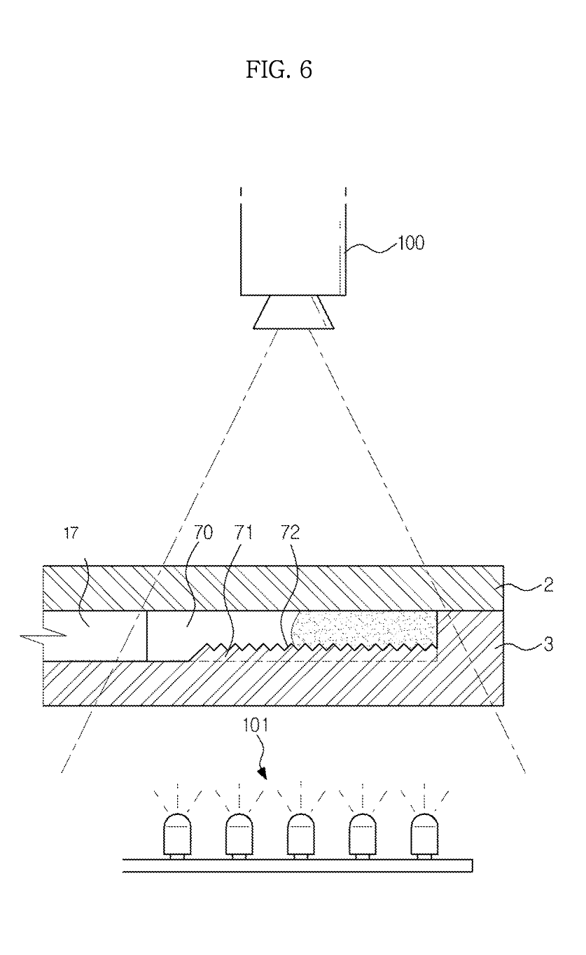

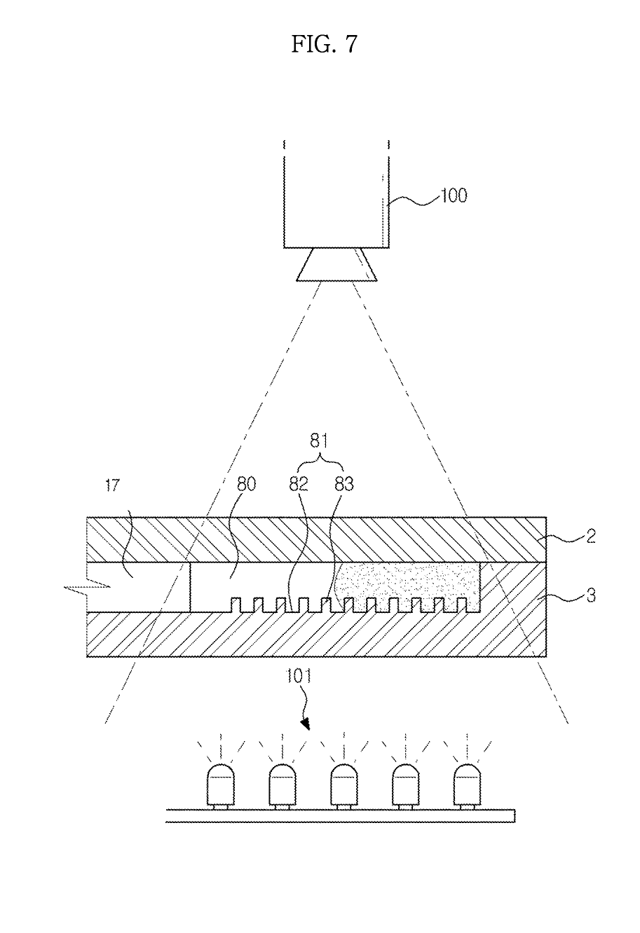

FIG. 5 is a cross sectional view illustrating a microfluidic system in accordance with another exemplary embodiment. FIG. 6 is a cross sectional view illustrating a microfluidic system in accordance with still another exemplary embodiment. FIG. 7 is a cross sectional view illustrating a microfluidic system in accordance with still another exemplary embodiment.

As shown in FIGS. 5 to 7, the microfluidic apparatus 1 may be provided with at least one protrusion 51 disposed therein. In addition, the protrusions 51 may be provided in a predetermined pattern at inner surfaces of chambers 60, 70, and 80, respectively. The pattern may be formed through etching. Etching refers to a process of eliminating a selected portion of the surface of a material by chemically causing corrosion by use of a corrosive, such as acid, in order to generate a desired pattern at a selected portion of the surface of a material.

In FIG. 5, there is shown an etching surface 61, serving as a protrusion that is provided at an inner surface of the chamber 60, and the difference in height is formed through the etching surface 61. Even in the case as such, as illustrated on FIG. 4, a difference in the rate of transmittance is shown when the chamber 60 is filled with a fluid, as compared to when the chamber 60 is filled with air. As such, a determination on the existence of the fluid within the chamber 60 may be possible. Providing the pattern at the inner surface of the chamber 60 through etching may add convenience to the manufacturing process, as the pattern may be provided on a mold for use with a corrosive during the manufacturing process.

As shown in FIG. 6, in another exemplary embodiment, the surface of a protrusion 71 at the inner surface of the chamber 70 is provided with a predetermined uniform pattern included thereon. As in the embodiment illustrated in FIG. 6, the pattern on the surface of the protrusion 71 is formed by the etching. In such a case, not only is the difference in height developed at the inner surface of the chamber 70 by the protrusion 71, but also the difference in height is developed by etching surface 72 of the protrusion 71. Thus, the difference in the rate of transmittance, which depends on the existence or the non-existence of the fluid may be clearly seen.

As shown in FIG. 7, in another exemplary embodiment, the chamber 80 is provided a protrusion 81 including a plurality of protrusion parts 83 protruded from an inner surface 82 of the chamber 80. As the difference in height is present between the inner surface 82 of the chamber 80 and the protrusion parts 83, an effect similar to the effect illustrated in FIGS. 4 to 6 may be provided.

The protrusions 61, 71, and 81 at inner surfaces of the chambers 60, 70, and 80 may be provided having various shapes thereof, and determining the existence of the fluid using the difference in the rate of transmittance may therefore be possible.

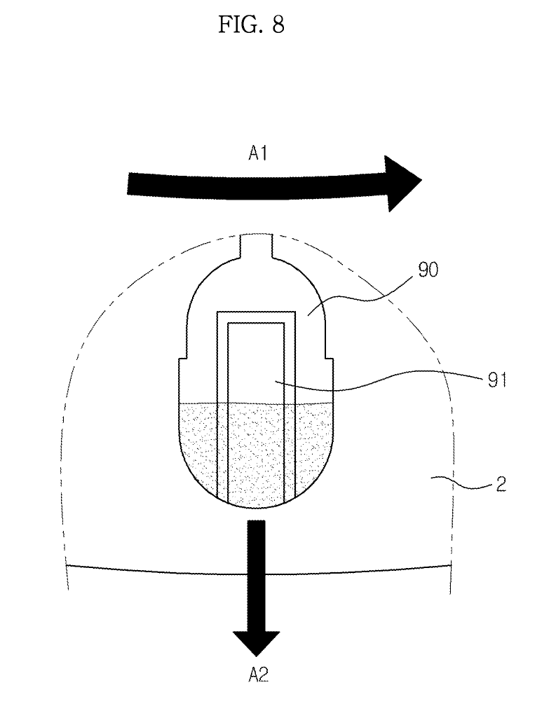

FIG. 8 is an enlarged perspective view illustrating a microfluidic apparatus in accordance with still another exemplary embodiment.

As illustrated in FIG. 8, when the microfluidic apparatus 1 is rotated in a first direction (A1 direction), a sample may be separated by the difference in specific gravity, and the sample may be moved toward a direction away from a central part 5 of the platform 4, that is, toward a second direction (A2 direction), which is the direction in which the centrifugal force is applied. In such a case, the protrusion 91 at an inner surface of the chamber 90 is formed extending toward the A2 direction, that is, the direction in which a centrifugal force is applied. A determination on the amount of remaining fluid as well as the existence of the fluid in the chamber 90 may be possible by use of the difference in the rate of transmittance. As the amount of the fluid, in addition to the existence of the fluid, in the chamber 90 may be determined, the QC may be performed more precisely.

As described above, microfluidic apparatuses according to the exemplary embodiments are capable of determining at least one of the existence and the amount of a transparent fluid with improved convenience in manufacturing by changing the structure of an inner surface of the microfluidic apparatus, and even in a case of a chamber having a smaller size, at least one of the existence and the amount of a fluid may be easily determined by changing the structure of an inner surface of the microfluidic apparatus.

Although a few exemplary embodiments have been shown and described, it would be appreciated by those skilled in the art that changes may be made in these embodiments without departing from the principles and spirit of the disclosure, the scope of which is defined in the claims and their equivalents.

What is claimed is:

1. A microfluidic apparatus comprising:
a platform comprising:
at least one chamber configured to accommodate a fluid;
at least one channel connected to the at least one chamber; and
at least one protrusion positioned at an inner surface of the at least one chamber and configured to show a difference in optical transmittance according to an existence of the fluid within the chamber.

2. The microfluidic apparatus of claim 1, wherein the protrusion includes a boundary part having a side that is slanted with respect to an inner wall of the chamber.

3. The microfluidic apparatus of claim 1, wherein the at least one protrusion is protrudes from a bottom surface of the at least one chamber.

4. The microfluidic apparatus of claim 3, wherein a surface of the at least one protrusion has a uniform pattern formed therein.

5. The microfluidic apparatus of claim 4, wherein the pattern is formed by an etching.

6. The microfluidic apparatus of claim 3, wherein the at least one protrusion comprises a plurality of protrusions forming a uniform pattern.

7. The microfluidic apparatus of claim 1, wherein the at least one chamber is an injection chamber into which the fluid is injected.

8. The microfluidic apparatus of claim 1, wherein the at least one chamber is a metering chamber configured to accommodate and discharge a determined amount of a fluid.

9. The microfluidic apparatus of claim 1, wherein the at least one chamber is a reaction chamber in which a reaction of the fluid takes place.

10. The microfluidic apparatus of claim 1, wherein the at least one chamber comprises a plurality of chambers including a reaction chamber and a checking chamber configured to check whether the fluid is entirely injected into the reaction chamber, and the protrusion part is disposed on an inner surface of the checking chamber.

11. A microfluidic system comprising:
a microfluidic apparatus comprising a platform, the platform comprising at least one chamber configured to accommodate a fluid and having at least one protrusion disposed at an inner surface thereof, and at least one channel connected to the at least one chamber;
a light source configured to radiate optical energy to the chamber; and
an optical sensor configured to determine at least one of an existence of the fluid in the chamber and an amount of the fluid in the chamber using the optical energy passing through the chamber.

12. The microfluidic system of claim 11, wherein the protrusion includes a boundary part having a side that is slanted with respect to an inner wall of the chamber.

13. The microfluidic system of claim 11, wherein the protrusion protrudes from a bottom surface of the chamber.

14. The microfluidic system of claim 11, wherein a surface of the at least one protrusion has a uniform pattern formed therein.

15. The microfluidic system of claim 11, wherein the at least one chamber is at least one of an injection chamber configured to have the fluid injected therein, a metering chamber configured to accommodate and discharge a determined amount of a fluid, and a checking chamber configured to check whether the fluid is entirely injected to a reaction chamber in which a reaction of a fluid takes place.

16. The microfluidic system of claim 15, wherein the protrusion is provided at an inner surface of at least one of the injection chamber, the metering chamber and the checking chamber.

17. The microfluidic system of claim 11, wherein the microfluidic apparatus is positioned in between the optical sensor and the light source.

18. The microfluidic system of claim 11, wherein the platform is configured to be rotated, and the protrusion is formed in a direction extending in a direction of centrifugal force caused by rotation of the microfluidic apparatus.

19. The microfluidic system of claim 11, wherein the at least one protrusion comprises a plurality of protrusions forming a uniform pattern.
